(19) United States
(12) Patent Application Publication
(10) Pub. No.: US 2005/0020355 A1
(43) Pub. Date: Jan. 27, 2005

(54) Apparatus and method for controlling an electronic gaming player station

(76) Inventor: Matthew Howard Haga, Austin, TX (US)

Correspondence Address: Russell D. Culbertson, Building One, Suite 360, 1250 Capital of Texas Highway, S., Austin, TX, 78746, US

(21) Appl. No.: 10/624,707

(22) Filed: Jul. 22, 2003

(51) Int. Cl. A63F 13/00

(52) U.S. Cl. 463/29

(57) ABSTRACT

A method includes the step of detecting whether a cover is present on a game ticket that is inserted at a player station in a gaming system. The method also includes disabling the player station from displaying gaming results associated with the game ticket in the event that the detecting step indicates that the cover is present on the game ticket. The method may further include producing a display or other output to notify the player when the cover has been detected. This notification may prompt the player to remove the cover from the game ticket and reinsert the ticket.

### TECHNICAL FIELD OF THE INVENTION

The present invention relates to gaming and gaming systems, and more particularly relates to a gaming system that utilizes a physical game ticket to distribute chances or outcomes in the game. The invention encompasses a method, apparatus, and program product for controlling a player station of the gaming system so as to prevent the player station from displaying results associated with a game ticket when a cover has not been removed from the game ticket.

### BACKGROUND OF THE INVENTION

Among the various games of chance available in many jurisdictions is a game referred to as “pull tab.” The traditional pull tab game is played with a large number of preprinted physical tickets or cards. Each pull tab ticket is printed with several symbols or indicia. The printed symbols are initially covered or obscured by some material such as a removable paper sheet or tab. The individual symbols printed on the pull tab ticket, or groups of such symbols, are correlated to an outcome or result in the game. Some of the pull tab tickets in a given pull tab game are printed with symbols or groups of symbols correlating to some prize or winning outcome, whereas some tickets are printed with symbols or groups of symbols correlating to no prize. In order to participate in the game, a player purchases the preprinted pull tab ticket at a pull tab vendor, removes the ticket cover material, and then reads the uncovered symbols to determine if the ticket wins in a prize. Winning tickets may be redeemed at designated ticket redemption locations.

Although traditional pull tab is a popular game, the game is limited in that the result of a chance in the game is displayed only through the symbols or indicia printed on the pull tab ticket. U.S. patent application Ser. No. 10/037,178, filed Oct. 23, 2001, and entitled “ELECTRONIC PULL TAB GAMING SYSTEM” shows an electronic pull tab system that allows the results in the pull tab game to be displayed in a more entertaining fashion. The entire content of application Ser. No. 10/037,178 is hereby incorporated herein by reference. The electronic pull tab gaming system disclosed in this prior application includes electronic player stations that can accept a pull tab ticket and display the results associated with the ticket. Results from the pull tab game are printed on the ticket and are also either encoded on the ticket or identifiable from data encoded on the ticket. In any event, this electronic pull tab gaming system may show the results of a purchased pull tab ticket in a more animated and thus more interesting and exciting manner than is possible using a physical ticket alone. In particular, the electronic player stations include display devices that may display the pull tab game results in a manner that imitates other games such as reel-type games (slot machines) or other casino games.

Regulations for pull tab games may require that the symbols printed on the pull tab ticket be covered prior to sale. Covering the symbols on the game ticket in a traditional pull tab game ensures that the results of the ticket are unknown to the purchasing player and the ticket seller at the time the ticket is sold. The purchasing player must purchase the ticket and then remove the cover or covers to see the results associated with the ticket. Regulations may also require that the player actually remove the cover in order to see the results associated with the ticket. However, in situations in which a player station reads result information encoded in some form on the game ticket, it may be possible for the player station to read the information and display the results with the cover still attached to the game ticket. This ability of an electronic player station to display results associated with a pull tab game ticket without having the cover removed from the ticket may prevent the systems utilizing such player stations from fully complying with applicable pull tab game regulations or standards.

### SUMMARY OF THE INVENTION

The present invention prevents a gaming system player station from displaying the results associated with a pull tab game ticket in the event that the cover of the game ticket has not been removed. The invention encompasses a method, apparatus, and program product for controlling a player station that is adapted to display results associated with a game ticket.

A method embodying the principles of the invention includes the step of detecting whether a cover is present on the game ticket that is inserted at the player station. The method also includes disabling the player station from displaying gaming results associated with the game ticket in the event that the detecting step indicates that the cover is present on the game ticket. Some forms of the invention may further include producing a display or other output to notify the player when the cover has been detected. This notification may prompt the player to remove the cover from the game ticket and reinsert the ticket.

The step of detecting whether the cover is present on game ticket preferably includes providing a cover sensor output. In some forms of the invention, the cover sensor output is interpreted to produce a logical signal, that is, either a logical high-level output or a-low-level output. The sensor output may be produced by any suitable sensor such as an optical sensor or a magnetic sensor for example.

In one form of the invention, the cover for the game ticket includes a feature that is detectable by the particular type of sensor employed in the invention. The step of detecting whether the cover is present on the game ticket includes attempting to detect or read the feature on the game ticket cover. Detecting the feature indicates that the cover is present on the game ticket. In this case, the method includes disabling the player station from displaying the gaming results associated with the game ticket. However, failing to detect the feature indicates that the cover is absent and the player station is allowed to operate in the normal fashion to display gaming results associated with the game ticket.

Other forms of the invention may include a feature on the game ticket itself in an arrangement in which the feature is not detectable by a sensor when the ticket cover is present. In this form of the invention, the step of detecting whether the cover is present on the game ticket includes attempting to detect the feature located on the game ticket. Detecting the feature indicates that the cover has been removed and the player station is allowed, according to invention, to operate normally. However, failing to detect the feature on the gaming ticket indicates that the cover is present on the gaming ticket, and the invention includes disabling the player station from displaying gaming results associated with the game ticket.

In some forms of the invention, the ability of the sensor to produce the desired sensor output is dependent upon a particular orientation of the game ticket in the player station. In these forms of the invention, a method embodying the principles of the invention may also include the step of detecting an orientation of the game ticket in the player station. In embodiments that detect the orientation of the game ticket, the player station may be disabled from displaying game results only when the cover detecting step indicates that the cover has been removed and the orientation detecting step indicates that the game ticket is properly inserted in the player station. The invention may further include the step of providing or displaying a message or other indication to the player in the event that the orientation determining step indicates that the game ticket is in an improper orientation. This indication prompts the player to remove the game ticket and reinsert the game ticket in the proper orientation.

A player station control apparatus according to the present invention includes a cover sensor and a processor connected to receive an output from the cover sensor. The processor is operable for disabling the player station from displaying gaming results when the cover sensor output indicates that the cover is present on the game ticket. Forms of the apparatus may also include an orientation sensor that provides an output indicative of the orientation of the game ticket inserted into the player station. In these forms of the invention, the processor also receives the orientation sensor output and may allow the player station to display results associated with the inserted ticket only when the orientation sensor output indicates that the game ticket is properly inserted and the cover sensor indicates the cover has been removed.

In preferred forms of the invention the processor operates under the control of program code to perform the required functions. This program code represents the program product according to the present invention. In one embodiment, the processor executes cover sensor reading code for reading the cover sensor output, and player station control code for disabling the player station when the cover sensor output indicates that the cover is present on the game ticket. In forms of the invention including a game ticket orientation sensor, the invention may include orientation sensor reading code for reading the orientation sensor output. The player station control code in these forms of the invention causes the player station to provide a misorientation indication when the orientation sensor output indicates that the game ticket is not properly oriented in the player station.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a gaming system that may issue a pull tab ticket and allow the results associated with the ticket to be displayed at a player station included in the system.

FIG. 2 is a diagrammatic representation of a point of sale terminal and player station of the gaming system shown in FIG. 1.

FIG. 3A is a representation of one side of a game ticket embodying the principles of the invention.

FIG. 3B is a representation of the opposite side of the game ticket shown in FIG. 3A.

FIG. 3C is a representation of the game ticket side shown in FIG. 3A, but with a cover embodying the principles of the invention secured over the game symbols.

FIG. 4 is a flow chart illustrating a method embodying the principles of the invention for controlling a gaming player station.

### DESCRIPTION OF PREFERRED EMBODIMENTS

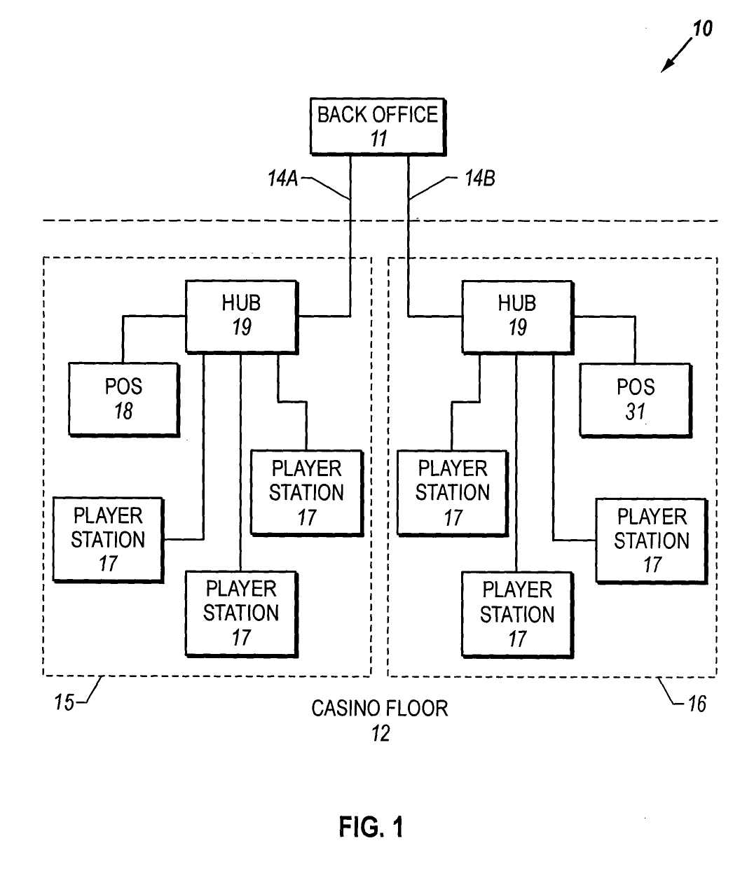

Referring to FIG. 1, a gaming system 10 in which the present invention may be employed includes a back office system 11 located in a secure area and a casino floor system 12 that is accessible to players. Casino floor system 12 allows players to participate in various games available through the gaming system and preferably allows players to establish and modify accounts in gaming system 10. Back office system 11 preferably maintains accounts and account balances for all players, maintains account information, and provides system usage reports and other reports useful in managing gaming system 10. Back office system 11 also preferably creates gamesets made up of a number of predetermined game records and selects game records in response to player requests made through casino floor system 12. As will be discussed further below, each game record corresponds to a chance in the respective game offered through system 10 and includes a predetermined result associated with the chance in the game.

Back office system 11 may include a number of separate processing devices interconnected through a suitable communications arrangement. For example, back office system 11 may comprise a local area network of individual processing devices connected to a suitable network communications device such as a switching hub (not shown). Communication links 14a and 14b are provided to provide communications from back office system 11 to the casino floor system 12. The specific arrangement of processing devices that may be included in back office system 11 and division of functions between these various processing devices will not be described here so as not to obscure the invention in unnecessary detail. For purposes of describing one preferred form of the present invention, it is necessary only to note that back office system 11 provides predetermined game records to casino floor system 12 which are then associated with a game ticket as will be described further below.

The casino floor devices shown in FIG. 1 are divided into two groups 15 and 16. Each group 15 and 16 includes a number of player stations 17 and a point-of-sale or cashier terminal (POS) 18, all connected to a local area network communications hub 19. Although not shown in the figure, each group may also include one or more remote point-of-sale (RPOS) terminals, and one or more kiosks also connected to the communications hub 19. The communications hub 19 of each casino floor group is connected to the back office system 11 for communications through a respective one of the communications lines 14a or 14b.

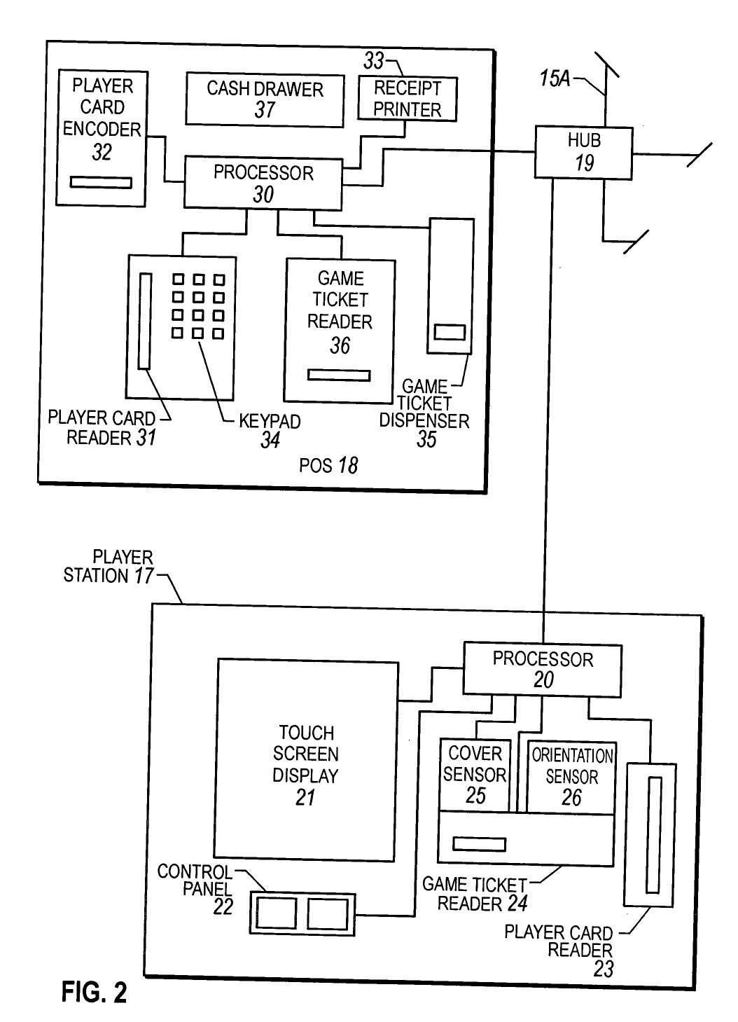

As shown in FIG. 2, each player station 17 includes a computer system having a processor 20, touch screen display 21, a control panel 22, a player card reader 23, a game ticket reader 24, and a cover sensor device 25. Player station 17 may also include a separate game ticket orientation sensor device shown at reference numeral 26, although some forms of the player station may omit such an orientation sensor within the scope of the invention or incorporate the orientation sensor function in game ticket reader 24 as will be discussed below. Player station software or program code executed by processor 20 receives information from player card reader 23 to log a player into back office system 11, and to operate the game ticket reader 24 to read the player's game ticket. The player station program code also causes display 21 to show graphic game representations indicating the results of game plays associated with the player's game ticket, unless the player station is disabled from displaying results according to the invention as will be described further below.

POS terminal 18 shown in FIG. 2, enables a player to open an account with the gaming system, add funds to their account, close or cash out their account, purchase game tickets, and redeem or provide results for game tickets. POS terminal 18 comprises a computer system having a processor 30 and a player/cashier interface including a player card reader 31, player card printer/encoder 32, a receipt printer 33, a keypad 34, a game ticket printer/encoder/dispenser (game ticket dispenser) 35, and a game ticket reader/verifier 36. POS terminal 18 also includes a cash drawer 37 which is accessible by a POS cashier or attendant.

Game system 10 and game system elements shown in FIGS. 1 and 2 are illustrated only for purposes of providing an example of a system in which the present invention may operate. Numerous variations are possible within the scope of the present invention. The present player station control invention may be employed in any gaming system in which results printed or encoded on a gaming ticket, and originally covered on the ticket with some obscuring medium, may be displayed at a player station or other display device. Also, many features and details of a gaming system with which the present player station control invention may be used have been omitted from FIGS. 1 and 2 so as not to obscure the invention in unnecessary detail. For example, it will be appreciated that processor 20 associated with player station 17 will commonly include random access memory, a mass storage device, system bus, network communications interface, and various other hardware components, the descriptions of which are unnecessary to an understanding of the present invention.

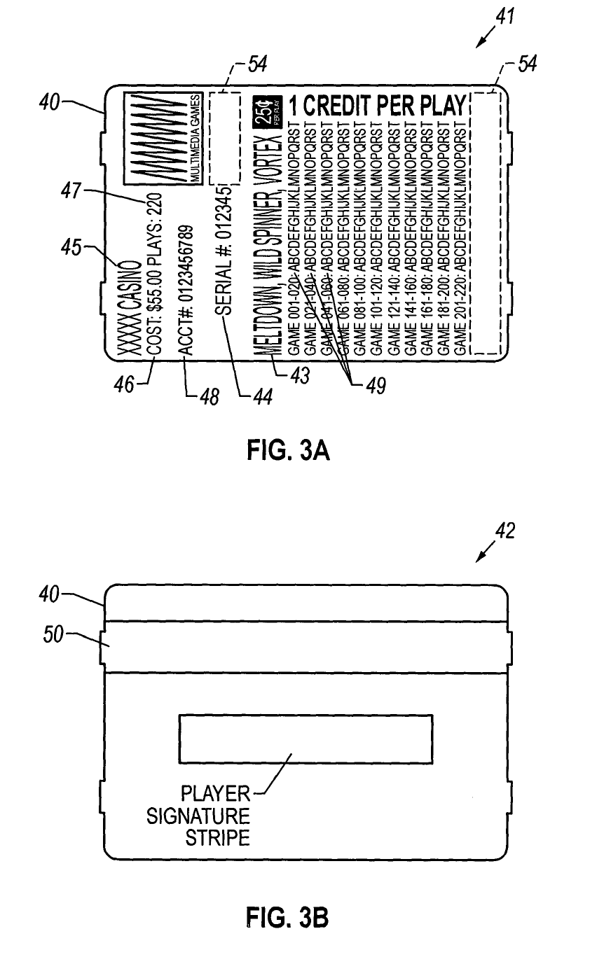

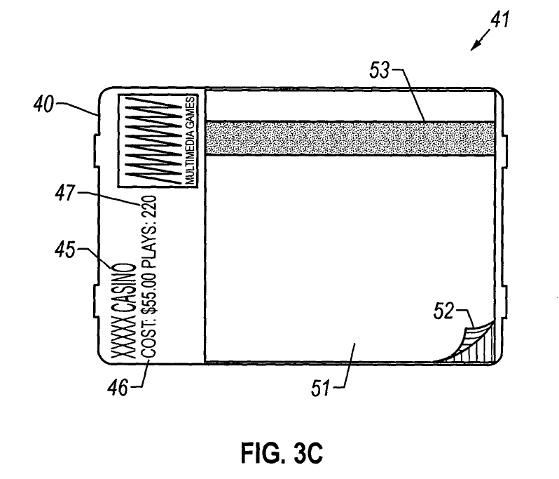

FIGS. 3A, 3B, and 3C show an example of a game ticket 40 that may be used in the gaming system 10 shown in FIGS. 1 and 2. Game ticket 40 includes a ticket substrate having a printed side 41 shown in FIG. 3A and a magnetic stripe side 42 shown in FIG. 3B. Each ticket 40 contains a number of ticket indicia or result codes, each representative of a game play outcome. These game play outcomes are each associated with one of the predetermined game records provided by back office system 11 and are purchased in a quantity at the discretion of the player.

Printed side 41 of ticket 40 shown in FIG. 3A preferably includes the name of the game presentation or game presentations 43 that may be used to display the game ticket results, ticket identifier or serial number 44, casino name 45, price or cost 46 of the ticket, a play quantity 47 comprising a value equal to the number of outcomes purchased, a player account number 48, and the printed ticket indicia representing the game play outcomes. The illustrated ticket indicia are printed in the form of a sequential list of prize indices or result codes 49 represented by the characters A, B, C, D, and so forth in FIG. 3A. These preferred prize indices or result codes 49 are selected from a set of available codes listed in a prize table for the indicated game. It will be appreciated that in an actual ticket the result codes 49 will be selected in some random or pseudo random fashion and will not appear in an order as shown in the example ticket 40. Regardless of their specific form, the ticket indicia are directly identifiable, that is, identifiable to the player without the aid of any decoding machine. Although all of the information printed on the game ticket may be printed at the POS terminal, some gaming systems with which the invention may be used may employ partially preprinted tickets and print at the POS terminals only information which is specific to the particular game ticket such as the prize indices or indicia 49.

The magnetic stripe side 42 of ticket 40 includes a stripe of magnetic data storage medium 50 which may be encoded at a POS terminal 18 with machine readable game play information which specifies the game play outcomes printed on the game ticket and preferably identifies the game plays or records assigned to the game ticket. The game play information may, for example, include the game serial number, the starting game record identifier identifying the starting game record purchased by the player, and the number of game play outcomes purchased. This starting game record identifier plus the number of game play outcomes/game records in the gameset sequence (a randomized game record sequence) after the starting record effectively specifies each game record and thus each game play outcome represented on the given game ticket. Alternatively, the game play information may include a ticket serial number or identifier which relates to a ticket data table or set of ticket data stored in back office system 11 or elsewhere in the gaming system 10. This set of ticket data specifies or identifies each game play outcome associated with the respective game ticket and preferably each assigned game record itself. Still other alternatives of a game ticket with which the present invention may be used may include the prize indices or result codes from the purchased game records themselves encoded in some machine readable fashion on magnetic medium 50.

Player station 17 may read the information stored an the game ticket 40 in any one of a variety of ways. For example, game ticket reader 24 may read the game play information automatically upon insertion of the ticket 40 into the reader, or in response to a separate player input that the player may make after they have inserted the game ticket. Game ticket reader 24 may alternatively read the game play information encoded on ticket 40 in response to a player verification input from back office system 11. Back office system 11 may provide this verification input after verifying player account information in response to information read from a player card by player card reader 23 at the player station. Alternatively, game play information may be read from game ticket 40 without requiring the player to be identified.

Numerous variations are possible in the gaming ticket within the scope of the present invention. In one variation, ticket reader 24 may read the printed results directly from the ticket rather than from the data carrier. In another variation, the magnetic stripe 50 may be located on the same side of the ticket as the printed results, that is, on the printed side 41. Substantially any layout of information and features on game ticket 40 is also possible according to the present invention.

The ticket indicia, which in the illustrated case comprise indices or result codes 49, printed on the printed side 41 of ticket 40, and perhaps other information on the printed side of the ticket, are covered with some material prior to the time that the ticket is dispensed to the player. Preferably, this cover material is applied immediately after the indicia or result codes 49 are printed on ticket 40 so that no one can see the game results printed on the ticket until the ticket is dispensed and the cover removed. In preferred forms of the invention, the cover material comprises a removable sheet of material that is affixed to the ticket substrate so that it may be peeled or torn off to reveal ticket indicia 49. Other forms of the invention may employ cover material comprising a coating that may be scratched off of the ticket substrate to reveal ticket result codes 49.

FIG. 3C shows game ticket 40 with a cover 51 secured on printed side 41. Cover 51 obscures in particular the ticket indicia or result codes 49 printed on the face of ticket 40, while leaving other portions of the printed side 41 of the ticket visible. The particular cover 51 shown in FIG. 3C comprises a peel-off sheet of material as indicated by the peeled back corner 52. This peel-off type cover may be secured in any suitable fashion and preferably with a low tack adhesive. Cover 51 may alternatively comprise a tear off sheet of cover material or a layer of scratch off material. Regardless of the particular type of cover, and the manner in which the cover is secured to ticket 40, it will be appreciated that a cover according to the present invention may extend over the entire surface of the ticket or less of the ticket than shown in the example of FIG. 3C. Also, although a single continuous cover is shown for purposes of example in FIG. 3C, forms of ticket 40 within the scope of the invention may include two or more separate covers covering different parts of the ticket or covers that are designed to be removed in sections rather than in one piece.

The game ticket cover 51 includes a feature 53, which, in the form of the invention shown in FIG. 3C, comprises a dark stripe running lengthwise along the exposed side of the cover material. This feature 53 is adapted to be detected by cover sensor 25 described above with reference to the player station shown in FIG. 2. More particularly, cover sensor 25 is in position to detect feature 53 in the event ticket 40 is inserted into the ticket reader 24 shown in FIG. 2 with cover 51 still in place on the ticket. Thus, processor 20 associated with player station 17 in FIG. 2 may use the output from cover sensor 25 in determining if the ticket 40 has been inserted with the cover 51 still attached. With ticket 40 inserted into reader 24, an output from sensor 25 produced in response to the presence of feature 53 indicates that cover 51 is still present on ticket 40. On the other hand, an output of sensor 25 produced in response to the absence of feature 53 (with ticket 40 inserted into reader 24) indicates that game ticket cover 51 had been removed.

An alternate form of the invention may use a feature 54 on the printed side of ticket 40 in lieu of feature 53 located on cover 51. In this form of the invention, sensor 25 produces one sensor output in response to the presence of feature 54 and a different output in response to the absence of feature 54. Because feature 54 is obscured, and thus not detectable by sensor 25, when cover 51 is present on ticket 40, a sensor output detecting that the feature is present indicates that the ticket cover has been removed. However, a sensor output from sensor 25 detecting that feature 54 is not present, indicates that cover 51 is still in place on ticket 40 obscuring feature 54 and causing the sensor to fail to detect the feature.

Many different types of sensors may be used for sensor 25 within the scope of the present invention. The particular type of sensor employed for sensor 25 will dictate the nature of the feature used on the ticket or ticket cover as described above using the example features 53 and 54. For example, a solid dark or nonreflective surface making up feature 53 or 54 may be detected by an optical sensor that is adapted to detect light reflected from a light source. The dark, nonreflective surface of feature 53 and 54 reflects little light from a light source and the absence of reflected light causes the sensor to produce a particular output. The detection of a certain level of reflected light indicates that the feature 53 or 54 is not present or obscured by a more light reflective material. In preferred forms of the invention employing an optical sensor for sensor 25, the optical sensor itself produces an analog voltage signal output that corresponds to the level of light picked up by the sensor. This analog output is communicated to processor 20 which has the ability to interpret the analog signal and convert the signal to a digital signal. That is, an analog output from the sensor in one range is interpreted as a high level logical signal and an output in another range is interpreted as a low level logical signal. The resulting logical signal is then acted upon in the process of either enabling or disabling the display of results at the player station 17.

Alternatively to the dark, nonreflective features 53 and 54 in the illustrated example, a feature within the scope of the present invention may comprise a material producing a magnetic field on the cover or ticket substrate. In this alternative, the sensor 25 would comprise a device capable of detecting the magnetic field. In yet another alternative within the scope of the present invention, the feature formed on the ticket cover or ticket itself may comprise a bar code or a series of magnetic field producing elements. These alternate forms of the invention would employ a sensor comprising a bar code reader or a magnetic code reader. A reading from the bar code or magnetic code reader would produce or indicate one signal state from the reader while the failure of a read when the ticket is inserted would produce or indicate the opposite signal state.

Although the illustrated embodiment indicates that cover feature 53 or ticket feature 54 could be used, a system embodying the principles of the invention could use both a cover feature and a ticket feature, provided the features were located at different points in relation to the ticket 40 or use different and noninterfering sensing technologies. Where both a cover feature and a ticket feature are used, agreement between the two sensor outputs would indicate that the cover is present or absent, while disagreement between the two sensor outputs would indicate some error.

It will be appreciated that the sensor device 25 may utilize other technologies and techniques to detect the presence or absence of the game ticket cover 51 depending upon the particular implementation of the gaming system 10. For example, a presence or absence of the game ticket cover 51 may be detected by computing a difference in weight of the game ticket 40 with a cover and the game ticket 40 without a cover. In this case, sensor 25 would comprise a device for detecting the weight of the ticket inserted into ticket reader 24. Thus, the sensor device 25 is not simply limited to the preferred “optical” or “magnetic” sensing technology.

Also, although the figures show a single element as the cover sensor 25, it will be appreciated that a plurality of separate sensing devices may be employed within the scope of the invention. Where the cover sheet or other material may be removed in sections, for example, multiple sensor elements may be used to detect the presence or absence of the various sections of cover material. However, even in this multiple cover section arrangement, a single sensor may be configured to sense various locations on the ticket either as ticket 40 is inserted into ticket reader 24 or as the sensor itself is manipulated with the ticket stationary in the ticket reader.

Interaction between the sensor device 25 and the player station processor 20 may be handled in a variety of ways within the scope of the invention as defined in the following claims. For example, in one embodiment the processor 20 is programmed to continuously receive and monitor the output from sensor 25 to detect a state change, or periodically poll the output from sensor 25. In another embodiment, processor 20 waits for an indication from reader 24 or some sensor associated with reader 24 that game ticket 40 has been inserted, and then reads the output of sensor 25 in response to an indication that a ticket has been inserted. In yet another embodiment, processor 20 may periodically poll both ticket reader 24 and cover sensor 25, and then act in response to the received outputs.

It will be appreciated from the figures illustrating game ticket 40 that the ticket may be inserted in several different orientations in ticket reader 24. The illustrated elongated rectangular ticket 40 maybe inserted in four different orientations for example. Yet the feature 53 and/or 54 may be limited to only a limited part of the surface of the ticket or cover material. Considering that the features 53 and 54 used in detecting the presence or absence of cover 51 may be limited to only a portion of the ticket or cover, the ticket must be inserted in a particular orientation in reader 24 in order for sensor 25 to provide an accurate indication of the presence or absence of cover 51. For example, if sensor 25 comprises an optical sensor and is positioned in relation to reader 24 to detect the dark stripe feature 53 shown in FIG. 3C when the ticket 40 is inserted in a “proper” orientation in the reader, the sensor will not be in position to detect feature 53 if the ticket is inserted upside down with the back side 42 facing the sensor 25. Thus, some forms of the invention may include an orientation sensor that provides an output that may be used to determine if the ticket is inserted in reader 24 in the desired or proper orientation.

An orientation sensor within the scope of the present invention may include a separate optical or other sensor positioned with respect to reader 24 to detect some feature of ticket 40 when the ticket is inserted in the proper position in reader 24. Such a separate sensor device is shown at 26 in FIG. 2. Alternatively, multiple sensors and corresponding ticket features may be used which together provide an output indicating whether or not the ticket is inserted in the proper orientation in reader 24. In another embodiment, the plurality of sensors may be located such that the presence or absence of the cover 51 is detected even when the game ticket 40 has been inserted improperly. In yet another embodiment, the physical game ticket 40 may be constructed in a manner that only permits its proper insertion in the game ticket reader 24.

One preferred form of the invention uses the ticket reading element associated with reader 24 for providing an output indicative of the orientation of the ticket in the reader. In this form of the invention, ticket reader 24 may read the ticket information from the game ticket 40 only when the ticket is oriented properly in the ticket reader. Thus, if ticket reader 24 successfully reads ticket information from ticket 40, the ticket must be properly inserted in the reader. On the other hand, failure of ticket reader 24 to read ticket information from ticket 40 indicates that the ticket is either defective in some way or not inserted in the proper orientation.

Another orientation sensor within the scope of the present invention is particularly suited for game tickets in which ticket information is encoded on a dark stripe of magnetic media associated with the ticket. In this form of the invention, the orientation sensor 26 comprises an optical sensor positioned in reader 24 to detect the presence of the dark stripe of magnetic medium when the ticket 40 is properly inserted in the ticket reader. An output of orientation sensor 26 indicating that the dark stripe of magnetic media is present indicates that the ticket is in the proper orientation and thus the output of sensor 25 should provide a true indication as to whether the cover is present on the ticket substrate. Processor 20 or other processors in the gaming system may also use this output from sensor 26 to help diagnose any error at player station 17 which prevents reader 24 from properly reading ticket information from gaming ticket 40.

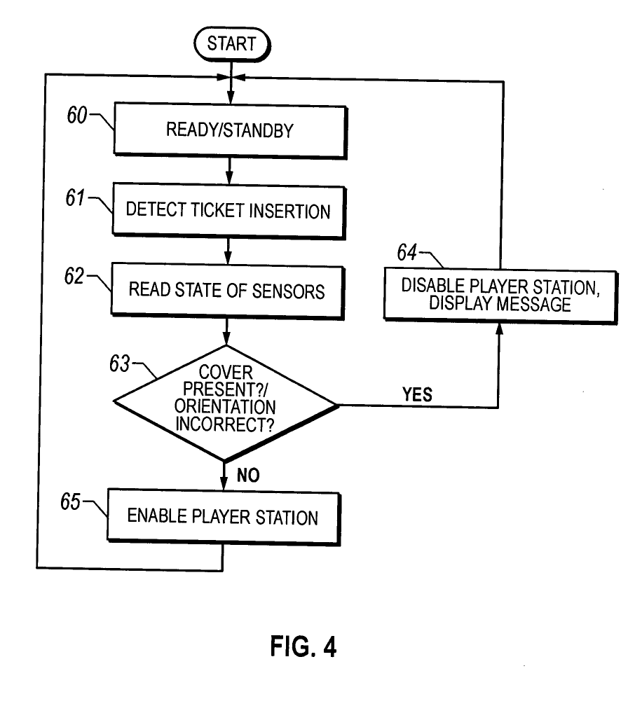

Methods embodying the principles of the invention and the operation of program product embodying the principles of the invention may be described now with reference to the flow chart of FIG. 4 and with periodic reference back to the structures shown in FIGS. 1 through 3C. In a ready/standby state shown at block 60 in FIG. 4, processor 20 associated with player station 17 is ready to receive inputs from the ticket reader 24 and the sensor device 25. Player station 17 may be initially placed in the ready/standby state on completion of the power-on, boot-up, or start-up phase.

At process block 61, the illustrated method includes detecting an insertion of the gaming ticket 40 into reader 24 at player station 17. The illustrated method then includes reading the state of the sensor or sensors necessary to make a determination as to whether ticket cover 51 is present on ticket 40. This sensor reading step is shown at process block 62 in FIG. 4. This step may include reading the output of a single sensor such as sensor 25, or reading the output of one or more cover sensors included at player station 17 together with an output from an orientation sensor such as sensor 26. In any case, the step is performed by processor 20 under the control of cover sensor reading code, and if an orientation is to be sensed, orientation sensor reading code. As indicated above, some forms of the invention do not require ticket detection prior to the sensor reading step. Thus, a method according to the present invention may not employ the ticket detection step 61.

The information read from the sensor or sensors at process block 62 is used by processor 20 in making the determination shown at decision block 63, that is, in determining whether cover 51 is present on gaming ticket 40 or has been removed from the ticket. This determination by processor 20 may include any one of a number of different operations depending upon the nature of the output from the sensor or sensors. For example, where the logical state interpreted from the output of a single sensor such as sensor 25 is used to determine whether the cover is present, the operation simply comprises determining if the state of the sensor output is equal to a value which has been predefined as indicating the cover is present. For an optical sensor sensing a feature on the cover, a logical low may be produced or interpreted when light is not reflected from the cover feature and this low output is predefined in the program code as indicating the cover is present. Alternatively, for an optical sensor that senses a feature on the ticket 40 which is detectable only when the cover is removed, a logical low output may be produced or interpreted when light is not reflected from the ticket feature and this low output is predefined as indicating the cover is not present.

As shown in FIG. 4, the determination at decision block 63 may also include determining if the orientation of ticket 40 in reader 24 is incorrect. This determination is performed by processor 20 operating under the control of orientation detection program code. For example, in one form of the invention, determining if the ticket orientation is incorrect includes evaluating the output of sensor 26 or an output of card reader 24.

If, at process block 63, it is determined that game ticket cover 51 is present, or in the illustrated method, that the orientation of the inserted ticket 40 in incorrect, then the process branches to block 64. At this point, the method includes disabling player station 17 from displaying any results associated with the game ticket. This disabling step is performed by processor 20 under the control of operational program code. The method at process block 64 may also include producing an appropriate display at player station 17. If the presence of cover 51 caused the branching to block 64, the display may include a message and/or audio at the player station 17 requesting that the player withdraw the ticket 40, remove the cover, and then reinsert the ticket. If the orientation was determined to be incorrect at decision block 63, the display produced at process block 64 may comprise a suitable misorientation notification. This misorientation notification may include a displayed message and/or an audio message requesting that the player withdraw the ticket, remove the cover if detected, and then reinsert the ticket in the proper orientation. Regardless of any display at process block 64, the process eventually returns to block 60 ready to start another cover detection sequence.

If it is determined at decision block 63 that game ticket 40 has been inserted correctly into reader 24 and cover 51 is absent from the ticket, then the process includes enabling player station 17, as shown at process block 65, to process the information read from the game ticket. The gaming system may or may not include further action on the part of the player in order to display results of one or more results associated with the gaming ticket. The present method, however eventually returns to process block 60 at which point the player station is ready to receive a new game ticket 40.

In forms of the invention in which a sensor or sensors are adapted to detect the presence or absence of cover material at different locations on ticket 40, the process of enabling player station to display results, may be limited to displaying only those results printed on ticket 40 in areas in which the cover material has been removed. Once all of the results printed in exposed areas on the ticket have been displayed, a process according to the invention may include causing player station 17 to produce a display prompting the player to remove the ticket 40 from reader 24 and remove one or more additional sections of cover material to expose additional printed on the ticket.

Various steps of FIG. 4 may be added, omitted, combined, altered, or performed in different sequences. For example, in one embodiment, process blocks 61 and 62 may be combined. Also, it will be appreciated that the steps of determining the presence of cover 51 and orientation of ticket may be separated into distinct steps. Each distinct step may branch to a separate display step for displaying a message appropriate to the determination at the respective decision block.

Those of ordinary skill in the art will appreciate that the hardware and methods illustrated herein may vary depending on the implementation. Additionally, those of ordinary skill in the art will appreciate that the program code of the present invention may be stored on various types of computer readable medium using any suitable program language either as object or source code.

The description of the present embodiment has been presented for purposes of illustration, but is not intended to be exhaustive or to limit the invention to the form disclosed. Many modifications and variations will be apparent to those of ordinary skill in the art. The specifically described embodiments were chosen in order to best explain the principles of the invention, the practical application, and to enable others of ordinary skill in the art to understand the invention. Various other embodiments and various modifications fall within the scope of the invention as defined in the following claims. For example, although above description indicates that each player station 17 includes a single processor 20 for performing all data processing required at the player station, it will be appreciated that the various processing steps required at the player stations may be distributed across multiple processors. The cover sensor reading code and player station control code for example may be executed by one processor located at the player station or elsewhere, and other operational code controlling player station functions may be executed by a separate processor within the scope of the present invention.

1. A method of controlling a player station adapted to display gaming results associated with a game ticket, the method including the steps of:
(a) detecting whether a game ticket inserted at the player station includes a cover; and
(b) disabling the player station from displaying gaming results associated with the game ticket in the event that the step of detecting whether the game ticket includes the cover indicates that the cover is present on the game ticket.

2. The method of claim 1 wherein the step of detecting whether the game ticket includes the cover includes producing a cover sensor output.

3. The method of claim 2 wherein the step of detecting whether the game ticket includes the cover includes determining an orientation of the game ticket in the player station, and further including the step of producing a ticket misorientation notification in the event the step of determining the orientation of the game ticket in the player station indicates that the game ticket has not been inserted properly.

4. The method of claim 3 further including the step of enabling the player station to display gaming results associated with the game ticket in the event that the step of detecting whether the game ticket includes the cover indicates that the cover is absent and the step of determining the orientation of the game ticket in the player station indicates that the game ticket has been inserted properly.

5. The method of claim 3 wherein the step of determining the orientation of the game ticket in the player station includes producing an orientation sensor output.

6. The method of claim 2 wherein the cover sensor is an optical sensor.

7. The method of claim 2 wherein the cover sensor is a magnetic sensor.

8. The method of claim 1 wherein the step of detecting whether the game ticket includes the cover includes the step of attempting to detect a feature located on the cover.

9. The method of claim 1 wherein the step of detecting whether the game ticket includes the cover includes the step of attempting to detect a feature located on a substrate of the game ticket.

10. An apparatus for controlling the operation of a gaming system player station for displaying gaming results associated with a game ticket, the apparatus including:
(a) a cover sensor associated with a game ticket reader on the player station, the cover sensor producing a cover sensor output; and
(b) a processor coupled to the cover sensor for disabling the player station from displaying gaming results associated with the game ticket when the cover sensor output indicates the presence of the cover on the game ticket.

11. The apparatus of claim 10 further including an orientation sensor coupled to the processor, the orientation sensor being operable to produce an orientation output indicative of an orientation of the game ticket in the game ticket reader.

12. The apparatus of claim 11 wherein the processor enables the player station to display gaming results when the cover sensor output indicates an absence of the cover and when the orientation output indicates that the game ticket has been inserted properly in the game ticket receiver.

13. The apparatus of claim 10 wherein the cover sensor is an optical sensor.

14. The apparatus of claim 10 wherein the cover sensor is a magnetic sensor.

15. The apparatus of claim 10 wherein the cover sensor is operable for detecting a feature located on the cover.

16. The apparatus of claim 10 wherein the cover sensor is operable for detecting a feature located on a substrate of the game ticket.

17. A program product for use in controlling a player station adapted to display gaming results associated with a game ticket, the program product being stored on a computer readable medium and including:
(a) cover sensor reading code for reading a cover sensor output from a cover sensor associated with a game ticket receiver on the player station; and
(b) player station control code for disabling the player station from displaying the results associated with the game ticket when the cover sensor output indicates that the cover is present on the game ticket.

18. The program product of claim 17 further including orientation sensor reading code for reading an orientation sensor output from an orientation sensor associated with the game ticket receiver.

19. The program product of claim 18 wherein the player station control code is operable for enabling the player station to display the results associated with the game ticket when the cover sensor output indicates an absence of the cover and when the orientation sensor output indicates that the game ticket has been inserted properly in the game ticket receiver.

20. The program product of claim 17 wherein the cover sensor output comprises a signal residing at either a first signal level or a second signal level.

21. The program product of claim 17 wherein the orientation sensor output comprises a signal residing at either a first signal level or a second signal level.

22. The program product of claim 17 further including orientation sensor processing code for deriving the orientation sensor output from a set of data read from the game ticket.
